(19) United States
(12) Patent Application Publication
(10) Pub. No.: US 2008/0018250 A1
(43) Pub. Date: Jan. 24, 2008

(54) Plasma display panel

(76) Inventors: Joon-Hyeong Kim, Suwon-si (KR); Jung-Suk Song, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/826,591

(22) Filed: Jul. 17, 2007

(30) Foreign Application Priority Data
Jul. 18, 2006 (KR) 10-2006-0067049

(51) Int. Cl. H01J 17/49

(52) U.S. Cl. 313/586

(57) ABSTRACT

A plasma display panel, including first and second substrates facing each other, a plurality of barrier ribs between the first and second substrates to define a plurality of discharge cells, the barrier ribs having at least one first portion and at least one second portion, the first portion being shorter than the second portion, a photoluminescent material in each discharge cell, a plurality of electrodes between the first and second substrates, a plurality of black layers between the first substrate and the barrier ribs, and at least one gap control unit between the first substrate and the barrier ribs, the at least one gap unit overlapping with the at least one first portion of the barrier ribs.

### BACKGROUND OF THE INVENTION

1. Field of the Invention

Embodiments of the present invention relate to a plasma display panel. More particularly, embodiments of the present invention relate to a plasma display panel having a structure capable of minimizing vibrations of uneven barrier ribs.

2. Description of the Related Art

A plasma display panel (PDP) is a flat display panel that displays images via gas discharge phenomenon, i.e., emission of visible light from a photoluminescent material disposed in a predetermined pattern between electrodes. In a conventional PDP, discharge gas may be supplied between two substrates having a plurality of electrodes, so that upon application of discharge voltage to the electrodes, the discharge gas may generate ultraviolet (UV) light to excite a photoluminescent material between the electrodes to emit visible light. PDPs may be classified with respect to a type of driving voltage applied to electrodes thereof, e.g., direct current (DC) PDPs, alternate current (AC) PDPs, and hybrid current PDPs, and/or with respect to a type of discharge and electrode configuration employed, e.g., a facing discharge type or a surface discharge type.

The conventional PDP may include front and rear substrates, a plurality of discharge electrodes coated with at least one dielectric layer, barrier ribs between the discharge electrodes to define discharge cells, and phosphor layers in the discharge cells. The barrier ribs of the conventional PDP, e.g., a three-electrode surface discharge AC type PDP, may be colored to reduce reflection of external light. For example, a predetermined amount of the main component employed to form the barrier ribs, i.e., tin oxide (TiO₂), may be replaced with a color component, so reflection of external light may be reduced to increase bright room contrast of the PDP.

However, a reduced amount of TiO₂ in the conventional barrier ribs may trigger expansion of portions of the barrier ribs during baking thereof and, thereby, produce uneven barrier ribs, i.e., barrier ribs having non-uniform height. Barrier ribs having non-uniform height may vibrate between the substrates of the PDP during operation thereof and, thereby, damage the barrier ribs and trigger leakage of the phosphor layers into the substrate, resulting in display defects, e.g., bright points. Accordingly, there exists a need for a plasma display panel having a structure capable of minimizing vibration of uneven barrier ribs.

### SUMMARY OF THE INVENTION

Embodiments of the present invention are therefore directed to a plasma display panel (PDP), which substantially overcomes one or more of the disadvantages of the related art.

It is therefore a feature of an embodiment of the present invention to provide a PDP having a structure capable of minimizing vibrations of uneven barrier ribs between the PDP substrates.

At least one of the above and other features and advantages of the present invention may be realized by providing a PDP including first and second substrates facing each other, a plurality of barrier ribs between the first and second substrates to define a plurality of discharge cells, the barrier ribs having at least one first portion and at least one second portion, the first portion being shorter than the second portion, a photoluminescent material in each discharge cell, a plurality of electrodes between the first and second substrates, a plurality of black layers between the first substrate and the barrier ribs, and at least one gap control unit between the first substrate and the barrier ribs, the at least one gap unit overlapping with the at least one first portion of the barrier ribs.

The at least one gap control unit may be in contact with a dielectric layer positioned between the first substrate and the barrier ribs. The at least one gap control unit may be integral with the dielectric layer. A height of the at least one gap control unit may be substantially identical to a height difference between the first and second portions of the barrier ribs. The at least one gap control unit may be in substantial contact with the first portion of the barrier ribs, the second portion of the barrier ribs, and the dielectric layer.

Each black layer may be between two electrodes and overlapping with a first portion of the barrier rib. Therefore, the dielectric layer may overlap with the black layer and the at least one gap control unit and positioned therebetween. The black layer may be thicker than the electrodes. The black layer may be thicker by at least about 30% than the electrodes.

A portion of the dielectric layer in contact with the at least one gap control unit may be thinner than other portions of the dielectric layer. The black layer may be equal to or thinner than the electrodes. A portion of the dielectric layer in contact with the at least one gap control unit may be thicker than other portions of the dielectric layer.

The barrier ribs may include a color layer. The barrier ribs may include a plurality of first and second portions intersecting in a grid pattern. Therefore, the gap control units may overlap with the first portions of the barrier ribs. The gap control units may have a stripe pattern.

The discharge electrodes may include sustain electrode pairs on the first substrate and address electrodes on the second substrate, each sustain electrode pair having an X electrode and a Y electrode, and each sustain electrode having a line electrode and a bus electrode. The black layer may include a cobalt oxide, a manganese oxide, an iron oxide, a carbon oxide, or a copper oxide. The first substrate may include a light transmitting material. The PDP may further include a passivation layer on the dielectric layer.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partial exploded perspective view of a plasma display panel (PDP) according to an embodiment of the present invention;

FIG. 2 illustrates an assembled cross-sectional view along line II-II of FIG. 1;

FIGS. 3A and 3B illustrate graphs of surface profiles of barrier ribs and a dielectric layer according to an embodiment of the present invention and the conventional art, respectively;

FIG. 4 illustrates a graph of a surface profile of a dielectric layer according to an embodiment of the present invention with respect to different baking temperatures; and

FIG. 5 illustrates an assembled cross-sectional view of a PDP according to another embodiment of the present invention.

### DETAILED DESCRIPTION OF THE INVENTION

Korean Patent Application No. 10-2006-0067049, filed on Jul. 18, 2006, in the Korean Intellectual Property Office, and entitled: “Plasma Display Panel,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

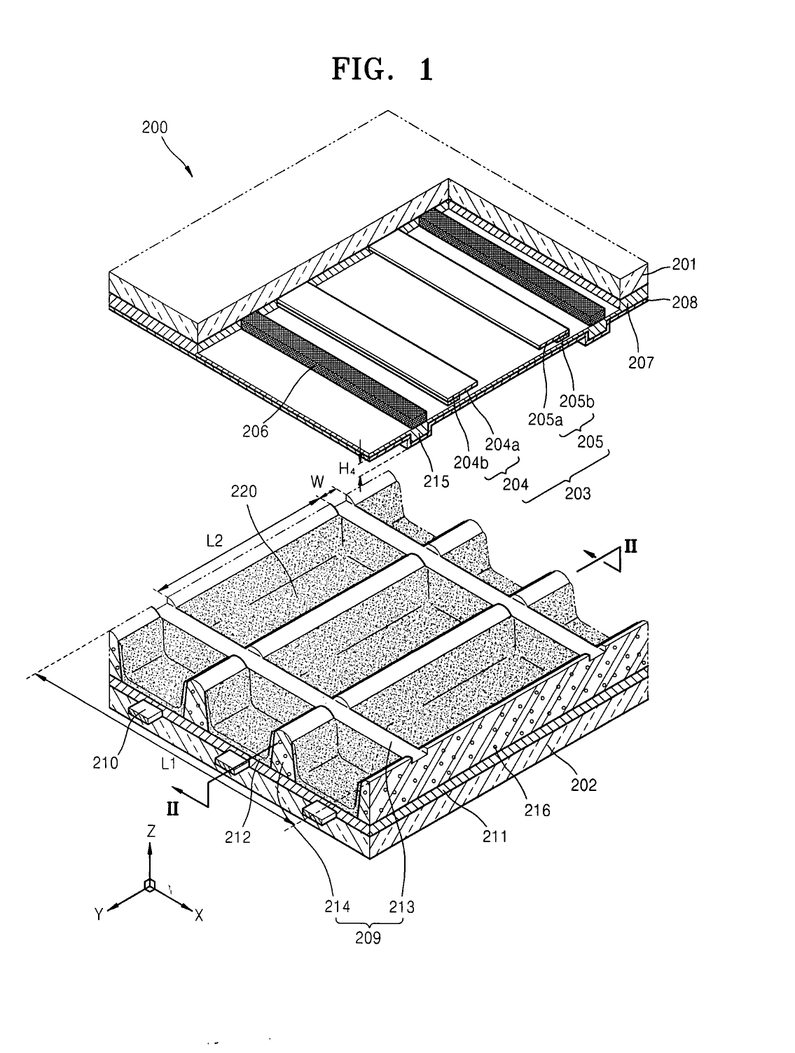

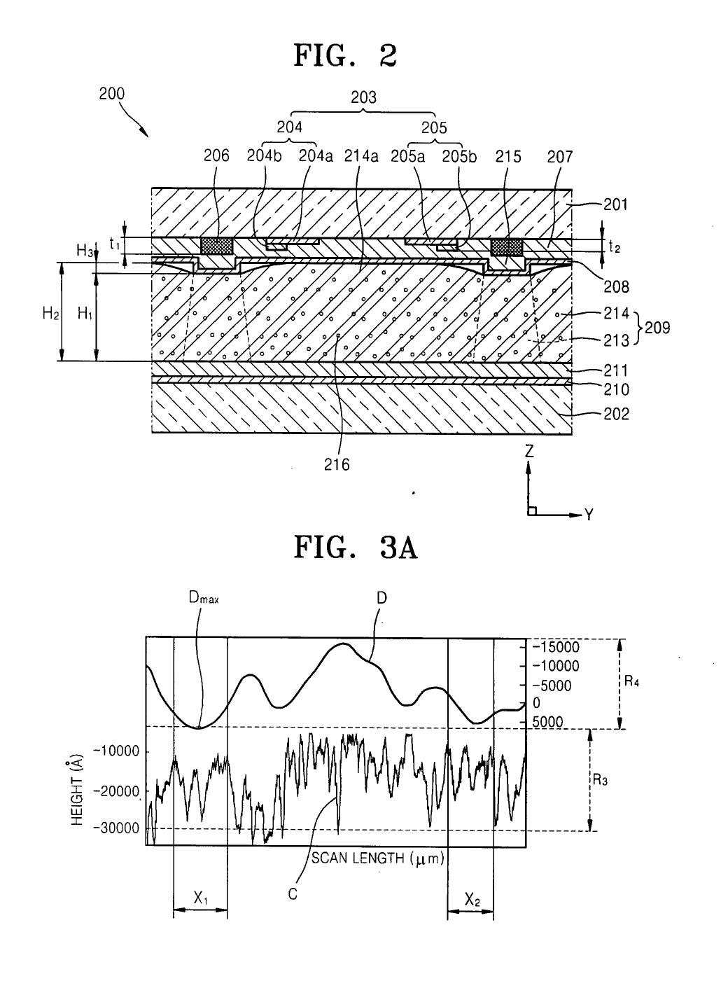

An exemplary embodiment of a plasma display panel (PDP) according to the present invention will now be described more fully with reference to FIGS. 1-2. As illustrated in FIGS. 1-2, a PDP 200 according to an embodiment of the present invention may include front and rear substrates 201 and 202, respectively, disposed in parallel to each other, a plurality of sustain electrode pairs 203, a plurality of black layers 206 between pairs of sustain electrodes 203, a plurality of address electrodes 210, a plurality of barrier ribs 209 defining discharge cells 220, and a plurality of phosphor layers 212.

The front substrate 201 of the PDP 200 according to an embodiment of the present invention may be formed of a material capable of transmitting visible light, such as a transparent panel, e.g., a panel made of soda lime glass, a semi-transparent panel, a colored panel, or a reflection panel. The rear substrate 202 may be formed of the same material as the front substrate 201, and may be positioned to face the front substrate 201, so that the plurality of sustain electrodes 203, address electrodes 210, and barrier ribs 209 may be disposed therebetween. A frit glass (not shown) may be coated along edges of an inner surface of the front substrate 201 to facilitate attachment of edges of the rear substrate 202 thereto, thereby providing a sealed discharge space between the front and rear substrates 201 and 202, i.e., a discharge space having no contact with an exterior of the PDP 200.

The sustain electrode pairs 203 of the PDP 200 according to an embodiment of the present invention may include a plurality of pairs of electrodes on an inner surface of the front substrate 201, i.e., a surface facing the rear substrate 202. Each pair of sustain electrodes 203 may include an X electrode 204 and a Y electrode 205. The X electrode 204 and the Y electrode 205 may be parallel to one another, and may be alternately disposed in parallel to the x-axis in the xy-plane, as illustrated in FIG. 1, so that each discharge cell 220 may be positioned between a pair of sustain electrodes 203, i.e., between an X electrode 204 and a Y electrode 205 of a pair of sustain electrodes 203.

Each X electrode 204 may include a X line electrode 204a extending along an array of discharge cells 220 and in parallel to the x-axis, and a X bus electrode 204b electrically connected to the X line electrode 204a. The X bus electrode 204b may be disposed in a stripe pattern along an upper surface of the X line electrode 204a. The Y electrode 205 may have a substantially similar configuration to a configuration of the X electrode 204. More specifically, the Y electrode 205 may include a Y line electrode 205a and a Y bus electrode 205b electrically connected to the Y line electrode 205a and configured in a stripe pattern. It should be noted, however, that other configurations of bus and lines electrodes of the sustain electrode pairs 203 are not excluded from the scope of the present invention.

The X and Y line electrodes 204a and 205a may be formed of a transparent conductive film, e.g., indium tin oxide (ITO), in order to increase an aperture ratio of the front substrate 201. The X and Y bus electrodes 204b and 205b may have multi-layered structures formed of a highly conductive metal, e.g., chromium-copper alloy (Cr—Cu—Cr), or single-layered structures formed of, e.g., a silver (Ag) paste, in order to increase electrical conductivity of the X and Y line electrodes 204a and 205a. Each sustain electrode 203 may have a second thickness t2, i.e., a distance as measured along the z-axis, as illustrated in FIG. 2.

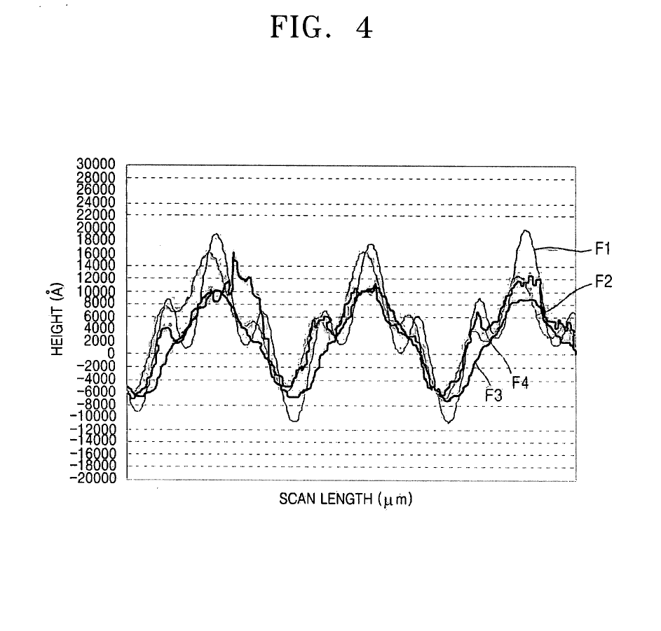

Each black layer 206 of the plurality of black layers 206 of the PDP 200 according to an embodiment of the present invention may have a rectangular shape, and may be disposed on the inner surface of the front substrate 201 between two pairs of sustain electrode pairs 203, i.e., between an X electrode 204 and a Y electrode 205 of two adjacent discharge cells 220. Each black layer 206 may be formed in a non-discharge region, i.e., overlapping with a first portion of the barrier ribs 213 as will be discussed in more detail below, in parallel to the plurality of the sustain electrodes 203 and therebetween in order to increase contrast. More specifically, the black layers 206 may be formed of a non-conductive oxide, e.g., a cobalt-based oxide, a manganese-based oxide, an iron-based oxide, a carbon-based oxide, a copper-based oxide, and so forth, to a first thickness t1 in order to increase contrast by reducing external reflection. The first thickness t1 of the black layers 206 may be relatively larger than the second thickness t2 of the sustain electrode pairs 203. The first thickness t1 of the black layers 206 may be at least about 30% thicker than the second thickness t2 of the sustain electrode pairs 203. Without intending to be bound by theory, it is believed that at least about 30% thickness difference may be capable of providing a substantially lower rate of generating bright points in the PDP 200, as will be discussed in more detail below with respect to FIG. 4.

The black layers 206 may be coated with a front dielectric layer 207, i.e., the front dielectric layer 207 may be printed on an entire region corresponding to the front substrate 201 to completely coat the plurality of sustain electrode pairs 203 and the black layers 206. Due to the differences between the first and second thicknesses t1 and t2, the front dielectric layer 207 may be deposited on the front substrate 201 at different thicknesses as well.

The plurality of address electrodes 210 of the PDP 200 according to an embodiment of the present invention may be disposed on an inner surface of the rear substrate 202, i.e., a surface facing the front substrate 201, and in a direction perpendicular to a direction of the sustain electrode pairs 203, i.e., in the xy-plane and parallel to the y-axis. The address electrodes 210 may have a stripe-pattern, so that each discharge cell 220 may have one corresponding address electrode 210. The plurality of address electrodes 210 may be coated with a rear dielectric layer 211, so that the rear dielectric layer 211 may be disposed between the address electrodes 210 and the front substrate 201. The rear dielectric layer 211 may be formed of a highly conductive material, e.g., a mixture of lead oxide, boron oxide and silicon oxide (PbO—B₂O₃—SiO₂).

The plurality of barrier ribs 209 of the PDP 200 according to an embodiment of the present invention may be positioned between the front and rear substrates 201 and 202 to define a plurality of discharge cells 220 therebetween. The plurality of barrier ribs 209 may include first barrier rib portions 213 disposed in parallel to one another and to the x-axis in the xz plane, and second barrier rib portions 214 disposed in parallel to the y-axis in the yz plane. A first length L1 of the first barrier rib portions 213, i.e., as measured along the x-axis, may be longer than a second length L2 of the second barrier rib portions 214, i.e., as measured along the y-axis, so that each second barrier rib portion 214 may extend between two sidewalls of adjacent first barrier rib portions 213 and in a perpendicular direction thereto. In other words, the first and second barrier rib portions 213 and 214 may be positioned to intersect one another to form, e.g., a grid pattern, as illustrated in FIG. 1.

It should be noted, however, that despite the different lengths of the first and second barrier rib portions 213 and 214 described above, the grid patterned structure of the barrier ribs 209 may provide second barrier rib portions 214 having relatively long lengths as compared to a width W of the first barrier rib portions 213 when viewed in a cross sectional view along the y-axis, as illustrated in FIG. 2. In other words, the second length L2 of the second barrier rib portions 214 along the y-axis may be longer than the width W of the first barrier rib portions 213 along the y-axis.

It should further be noted that other barrier rib patterns, e.g., a meander pattern, a delta pattern, a waffle pattern, a honeycomb pattern, and so forth, are not excluded from the scope of the present invention. Accordingly, even though the discharge cells 220 illustrated in FIG. 1 have a rectangular cross sectional area, other structures and cross-sectional areas of discharge cells 220, e.g., polygonal, circular, oval, and so forth, are not excluded from the scope of the present invention either.

The barrier ribs 209 may be formed of a white inorganic material, e.g., TiO₂, and include a coloring layer 216. The coloring layer 216 may be mixed with the, e.g., TiO₂, prior to formation of the barrier ribs 209. Alternatively, the coloring layer 216 may be coated onto outer surfaces of the barrier ribs 209 after formation thereof. Without intending to be bound by theory, it is believed that use of the coloring layer 216 in the barrier ribs 209 may modify the white color of the, e.g., TiO₂ and, thereby, increase luminance efficiency, e.g., overall luminance efficiency of the discharge cells 220 or luminance efficiency of predetermined discharge cells 220, by increasing the color temperature of an image. Further, use of the coloring layer 216 in the barrier rib 209 may increase bright room contrast by reducing reflection of an external light from the barrier ribs 209.

The plurality of barrier ribs 209 may be formed by, e.g., a baking process. Without intending to be bound by theory, it is believed that because of the material, i.e., reduced amount of TiO₂, and geometrical structure of the first and second barrier rib portions 213 and 214, i.e., differences between the first and second lengths L1 and L2, as well as differences between the second length L2 and the width W, the baking process may form barrier ribs 209 having non-uniform height, i.e., a distance as measured along the z-axis. More specifically, a reduced amount of TiO₂ in the barrier ribs 209 due to use of the coloring layer 216 may trigger vertical expansion of the second barrier rib portion 214 due to a relative long length thereof as compared to the width W of the first barrier rib portion 213. The first barrier rib portions 213 may have a smaller vertical expansion as compared to the vertical expansion of the second barrier rib 214 due to the short width W thereof along the y-axis. Therefore, the second barrier rib portion 214 may have a second height H2 that is higher than a first height H1 of the first barrier rib portions 213, as illustrated in FIG. 2. More specifically, the second height H2 may be higher than the first height H1 by at least a third height H3, as further illustrated in FIG. 2.

The barrier ribs 209 may include gap control units 215, as illustrated in FIGS. 1-2. The gap control units 215 may be positioned between the front substrate 201 and the barrier ribs 209 to compensate for a height difference between the first and second heights H1 and H2 of the first and second barrier rib portions 213 and 214. In particular, each gap control unit 215 may be formed to have a fourth height H4, as illustrated in FIG. 1, and may protrude vertically in a downward direction from a surface of the front dielectric layer 207 toward a respective first barrier rib portion 213 of the barrier ribs 209, i.e., each gap control unit 215 may substantially overlap with a respective black layer 206 and a respective first barrier rib portion 213. The fourth height H4 of the gap control unit 215 may have a substantially same height as the third height H3, so that upon assembly of the first and second substrates 201 and 202 and formation of the plurality of the barrier ribs 209 therebetween, the gap control units 215 may fit on upper surfaces of the first barrier rib portions 213, i.e., between upper portions of adjacent second barrier rib portions 214. The length of the gap control units 215 may be substantially similar to or shorter than the first length L1 of the first barrier rib portions 213.

Without intending to be bound by theory, it is believed that formation of the gap control units 215 between the first substrate 201 and the first barrier rib portions 213 may compensate for lower height of the first barrier rib portions 213 and, thereby, provide a uniform height of the barrier ribs 209. Accordingly, upon coupling of the barrier ribs 209 with the front substrate 201, spaces between the front substrate 201 and the first barrier rib portions 213, i.e., gaps due to higher height H2 of the second barrier rib portions 214, may be reduced or eliminated. Elimination of such spaces may provide contact between an entire upper surface of the barrier ribs 209 and a lower surface of the front substrate 201, thereby minimizing vibrations of the barrier ribs during operation of the PDP and the resultant damage thereof.

In this respect, it should be noted that formation of the gap control units 215 and height thereof may correspond to a thickness of the front dielectric layer 207 at predetermined regions. More specifically, the thickness of the front dielectric layer 207 in portions overlapping with the black layers 206 and the sustain electrodes 203 vary to correspond to the height of the gap control units 215 in order to provide a uniform height of the barrier ribs 209. In other words, for example, the first thickness t1 of the black layer 206, the fourth height H4 of the corresponding gap control unit 215, and the thickness of the front dielectric layer 207 therebetween, as illustrated in FIG. 2, may be adjusted to maintain uniform height of the barrier ribs 209, i.e., to minimize vibrations upon coupling of the first and second substrates 201 and 202. Further, formation of the barrier ribs 209 with uniform height may provide a substantially minimized number of bright points in the PDP 200, as will be discussed with respect to FIG. 4.

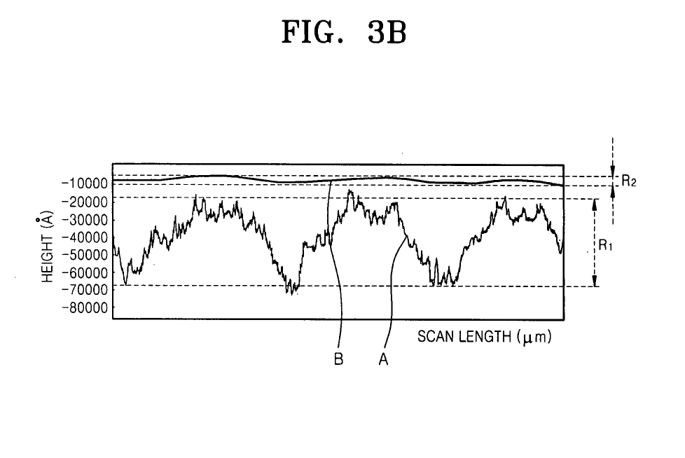

More specifically, as illustrated in FIGS. 3A and 3B, the surface profile of the front dielectric layer 207 may change due to incorporation of the gap control units 215 and, thereby, minimize bright points in the PDP 200. In detail, FIGS. 3A and 3B illustrate respective surface profiles of the present invention, i.e., the front dielectric layer 207 and the barrier ribs 209 of the PDP 200, as compared to the conventional art, i.e., a PDP having non-uniform barrier ribs without the gap control units 215 of the present invention.

In further detail, as illustrated in FIG. 3A, the barrier ribs 209 and the front dielectric layer 207 of the PDP 200 exhibit surface roughness values, i.e., vertical height variation, of 2 to 3 μm and 2.5 μm, respectively, as indicated by R3 and R4 on curves C and D. In this respect, it is noted that the gap control units 215 contribute surface roughness variation, i.e., indicated by Dmax, above the upper surfaces of the first barrier rib portions 213, i.e., as indicated by regions X1 and X2. The surface roughness of the barrier ribs 209, i.e., R3 with respect to curve C, is substantially similar to the surface roughness of the conventional barrier ribs indicated by R1 with respect to curve A in FIG. 3B, i.e., range of approximately 5 μm. However, the surface roughness of the front dielectric layer 207, i.e., indicated by R4 with respect to curve D, is substantially larger as compared to the surface roughness of the front dielectric layer in the conventional art indicated by R2 with respect to curve B in FIG. 3B, i.e., a value of about 2.5 μm as opposed to a range of approximately 0.3 μm. Accordingly, bright points may be reduced or eliminated due to an offset action of the height difference of the barrier ribs 209.

FIG. 4 illustrates a graph of a surface profile of the front dielectric layer 207 according to baking temperatures in the PDP 200. When the gap control unit 215 protrudes approximately 2.8 μm from the surface of the front dielectric layer 207 at a temperature of 550° C., i.e., curve F1, the rate of generating bright points in the PDP 200 is 0.5%. When the gap control unit 215 protrudes approximately 2.2 μm from the surface of the front dielectric layer 207 at a temperature of 560° C., i.e., curve F2, the rate of generating bright points in the PDP 200 is 3%. When the gap control unit 215 protrudes approximately 1.7 μm from the surface of the front dielectric layer 207 at a temperature of 570° C., i.e., curve F3, the rate of generating bright points in the PDP 200 is 5%. When the gap control unit 215 protrudes approximately 1.5 μm at a temperature of 580° C., i.e., curve F4, the rate of generating bright points in the PDP 200 is 10%. Accordingly, as the height of the gap control unit 215 increases, the rate of generating bright point decreases due to the offset action with the barrier ribs 209.

An operation of the PDP 200 having the above structure may be as follows. A predetermined voltage from an external power source may be applied to the address electrodes 210 and to the Y electrodes 205 to select discharge cells 220 to be operated, i.e., discharge cells 220 to emit visible light. Wall charges may accumulate on inner walls of the selected discharge cells 220.

Next, positive voltage may be applied to the X and Y electrodes 204 and 205, i.e., the voltage applied to the Y electrode 205 may relatively higher than the voltage applied to the X electrode 204, so that the wall charges may migrate with respect to the voltage difference between the X electrode 204 and the Y electrode 205. Due to the migration of the wall charges, the wall charges may collide with gas atoms in the discharge cells 220 and, thus, generate plasma discharge. The plasma discharge may begin at discharge gaps of the X and Y electrodes 204 and 205, i.e., location of a relatively strong electric field, and may expand outward. When the voltage difference between the X and Y electrodes 204 and 205 is lower than the discharge voltage as a result of the discharge, space charges and wall charges may be formed in the discharge cells 220. When the polarities of the voltages applied to the X and Y electrodes 204 and 205 are reversed, discharge may be re-generated. When this process is repeated, discharge may be stably generated. UV light triggered by the discharge may excite the phosphor layers 212 coated in the discharge cells 220 to emit visible light and form images.

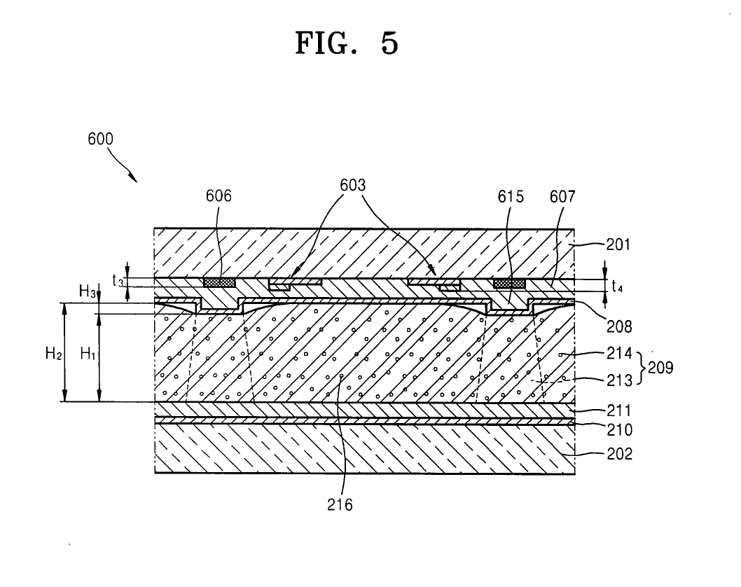

According to another exemplary embodiment of the present invention illustrated in FIG. 5, a PDP 600 may be similar to the PDP 200 described previously with respect to FIGS. 1-4 with the exception of having a plurality of black layers 606 having a third thickness t3 that may be equal to or smaller than a fourth thickness t4 of sustain electrode pairs 603, i.e., X electrode 204 and Y electrode 205. Accordingly, a front dielectric layer 607 of the PDP 600 may have a larger thickness in regions corresponding to gap control units 615 of the PDP 600 as compared to the thickness of the front dielectric layer 207 described previously with respect to FIGS. 1-4.

The PDP according to embodiments of the present invention may be advantageous in forming gap control units to level the barrier ribs into a uniform height to minimize damage to the barrier ribs and to reduce the rate of generating bright points.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
first and second substrates facing each other;
a plurality of barrier ribs between the first and second substrates to define a plurality of discharge cells, the barrier ribs having at least one first portion and at least one second portion, the first portion being shorter than the second portion;
a photoluminescent material in each discharge cell;
a plurality of electrodes between the first and second substrates;
a plurality of black layers between the first substrate and the barrier ribs; and
at least one gap control unit between the first substrate and the barrier ribs, the at least one gap control unit overlapping with the at least one first portion of the barrier ribs.

2. The PDP as claimed in claim 1, wherein the at least one gap control unit is in contact with a dielectric layer between the first substrate and the barrier ribs.

3. The PDP as claimed in claim 2, wherein the at least one gap control unit is integral with the dielectric layer.

4. The PDP as claimed in claim 1, wherein a height of the at least one gap control unit is substantially identical to a height difference between the first and second portions of the barrier ribs.

5. The PDP as claimed in claim 2, wherein the at least one gap control unit is substantially in contact with the first portion of the barrier ribs, the second portion of the barrier ribs, and the dielectric layer.

6. The PDP as claimed in claim 2, wherein each black layer is between two electrodes and overlapping with a first portion of the barrier rib.

7. The PDP as claimed in claim 6, wherein the dielectric layer overlaps with the black layer and the at least one gap control unit and is positioned therebetween.

8. The PDP as claimed in claim 7, wherein the black layer is thicker than the electrodes.

9. The PDP as claimed in claim 8, wherein the black layer is thicker by at least about 30% than the electrodes.

10. The PDP as claimed in claim 7, wherein a portion of the dielectric layer in contact with the at least one gap control unit is thinner than other portions of the dielectric layer.

11. The PDP as claimed in claim 7, wherein the black layer is equal to or thinner than the electrodes.

12. The PDP as claimed in claim 11, wherein a portion of the dielectric layer in contact with the at least one gap control unit is thicker than other portions of the dielectric layer.

13. The PDP as claimed in claim 1, wherein the barrier ribs include a color layer.

14. The PDP as claimed in claim 1, wherein the barrier ribs include a plurality of first and second portions intersecting in a grid pattern.

15. The PDP as claimed in claim 14, further including a plurality of gap control units overlapping with the first portions of the barrier ribs.

16. The PDP as claimed in claim 15, wherein the gap control units have a stripe pattern.

17. The PDP as claimed in claim 15, wherein a height of the gap control units is identical to a height difference between the first and second barrier rib portions.

18. The plasma display panel of claim 17, wherein upper surfaces of the barrier ribs and a lower surface of the first substrate are coupled by surface contact of the gap control units.

19. The PDP as claimed in claim 1, wherein the electrodes include sustain electrode pairs on the first substrate and address electrodes on the second substrate, each sustain electrode pair having an X electrode and a Y electrode, and each sustain electrode having a line electrode and a bus electrode.

20. The PDP as claimed in claim 1, wherein the black layer includes a cobalt oxide, a manganese oxide, an iron oxide, a carbon oxide, or a copper oxide.

21. The PDP as claimed in claim 1, further comprising a passivation layer on the dielectric layer.

22. The PDP as claimed in claim 1, wherein the first substrate is transparent.
